(19) United States
(12) Patent Application Publication
(10) Pub. No.: US 2004/0169990 A1
(43) Pub. Date: Sep. 2, 2004

(54) Antistatic protector for resin tube

(76) Inventor: Yuichi Wada, Aichi-ken (JP)

Correspondence Address: Joseph J. Jochman, ANDRUS, SCEALES, STARKE & SAWALL, LLP, 100 East Wisconsin Avenue, Suite 1100, Milwaukee, WI, 53202-4178, US

(21) Appl. No.: 10/788,701

(22) Filed: Feb. 27, 2004

(30) Foreign Application Priority Data
Feb. 27, 2003 (JP) 2003-052065

(51) Int. Cl. H02H 1/00

(52) U.S. Cl. 361/212

(57) ABSTRACT

An antistatic protector for resin tube integrally has a mounting portion, a connecting portion, for example, including a through slit, and a relatively elongate connective portion bridging between the mounting portion and the connecting portion. The antistatic protector is arranged, for example, such that the mounting portion is fitted on a fit-on portion of a quick connector and earth member is inserted in the through slit of the connecting portion.

### BACKGROUND OF THE INVENTION

The present invention relates to an antistatic protector or antistatic device for piping to prevent electrical charging or static charging of a resin tube adapted to vehicle piping.

Recently, a resin tube formed relatively thin-walled, which is lightweight and excellent in handling, is used in fuel piping for vehicle. As a resin tube does not have sufficient flexibility, the resin tube is preformed with a bend according to a piping arrangement or is formed with corrugation for flexibility. And, such resin tube is arranged to join some fuel system components, and is connected with a pipe via a connector. For example, the connector has a tube connecting portion on one axial end, and retainer means on an opposite axial end. In case that thus configured connector is adapted to connect the resin tube with the pipe, the tube connecting portion is relatively press-fitted in a connecting end portion of the resin tube, thereby the resin tube is tightly fitted to an outer periphery of the tube connecting portion, and the pipe is relatively inserted into an opening on an end of the connector so as to engage with the retainer means in locked relation.

By the way, the resin tube is charged with static electricity generated due to friction with an internal fluid, namely fuel. Especially, in case that the resin tube is adapted in fuel piping to connect a fuel tank and an engine and disposed downstream of a filter for filtering fuel, a fuel which is electrostatically charged when filtered flows in the resin tube, and the resin tube is much electrostatically charged accordingly. As a result, there is a danger that a gasoline vapor takes fire in the piping due to electrostatically charge. And, discharge sparks may fly on the charged resin tube, and this might make holes in the resin tube and result in failures such as leakage of fuel. Therefore, antistatic means are preferably constructed to protect the resin tube from being electrostatically charged in piping.

A number of such antistatic means have been already known. In one antistatic means, a metal spring is disposed in a connector to be connected to a resin tube (for example, refer to the Patent Document 1). And, when the resin tube is connected with a metal pipe via the connector, the spring contacts the resin tube and the pipe, and thereby the resin tube is electrically connected with the metal pipe. In another antistatic means, a connector to be connected to a resin tube is made of conductive material, and a metal washer member is fitted in the connector (for example, refer to Patent Document 2). And, when a metal pipe is inserted in and connected to the connector, the washer member contacts the metal pipe, and the resin tube is electrically connected with the metal pipe via the connector and the washer member, while the metal pipe is earthed to protect the resin tube from being electrostatically charged. Or, in yet another antistatic means, conductive interposed layer or electrostatic discharge interposed layer is formed in outer layer of a resin tube (for example, refer to Patent Document 3). And, a resin tube is connected to a connector so as to contact the conductive interposed layer with the connector, and thereby the resin tube is electrically connected to a pipe via the connector, while the pipe is earthed to protect the resin tube from being electrostatically charged.

The Patent Document 1, the Patent Document 2 and the Patent Document 3, all disclose such technology that conductivity of a pipe is applied to protect against electrical charging of components in piping. By the way, in case of a metal pipe, the pipe is usually coated with anti-rust coating. If the anti-rust coating is made of fluorine-type resin, for example, Teflon (trademark of DuPont), of thickness from a few μm(micrometers) to some ten μm and having a lot of microscopic pores, conductivity is maintained in the pipe. However, if the anti-rust coating is made of resin, for example, nylon, of thickness of about 150 μm for improved anti-rust property, conductivity of the pipe is disturbed partly because the coating has no microscopic pores, and as a result, such antistatic means cannot be constructed.

In order to solve the above problems, further another technology is disclosed where a connector to be connected to a resin tube is made of conductive material and the connector is electrically connected to a car body or a side of a car body with lead wire or clip to be earthed (for example, refer to Patent Document 4). Such construction makes it possible to protect the resin tube effectively from being electrostatically charged, even if a pipe to be connected with the resin tube does not exhibit conductivity, for example, due to nylon coating.

Patent Document 1 JP, A, 2002-295761

Patent Document 2 JP, A, 2001-74180

Patent Document 3 JP, A, 11-118073

Patent Document 4 JP, A, 11-13574

However, in such construction that a connector is attached to a side of a car body by adapting a clip, the connector should be located close to the side of a car body. That limits considerably freedom of layout in piping arrangement.. And, it bothers a worker to connect the lead wire to the connector and the side of the car body, and consequently connecting procedure in piping will be a bothersome work.

Accordingly, it is an object of the present invention to provide an antistatic protector for resin tube to be adapted to protect a resin tube from being electrostatically charged via a connector in piping arrangement, which is easily mounted to the connector and a side of a car body and does not too much restrain freedom of layout in piping arrangement.

### SUMMARY OF THE INVENTION

In order to achieve aforementioned object, there is provided a novel antistatic protector for resin tube to be mounted to a conductive connector which is adapted to connect or join a resin tube and a pipe in vehicle or automotive piping in order to earth the resin tube via the conductive connector. The antistatic protector or antistatic device for resin tube according to the present invention comprises a mounting portion to be mounted to an outer periphery of the connector, a connecting portion to be connected to an earth member provided on a car body or a side of a car body, and an elongate or relatively elongate connective portion to join the mounting portion and the connecting portion or bridge between the mounting portion and the connecting portion. The mounting portion, the connecting portion and the connective portion are formed from conductive elastic material so as to have flexibility respectively. The resin tube is required to be provided with electrical conductivity. So, preferably the resin tube is formed with conductive layer on a side of inner layer or inner peripheral surface, in order not to disturb other functions required to the resin tube such as low permeability to internal fluid. The mounting portion, the connecting portion and the connective portion, that is, the antistatic protector is formed from elastic material, for example, rubber elastic material such as vulcanized rubber or thermoplastic elastomer so as to have elasticity Moreover, the connective portion is formed elongate or relatively elongate. This configuration permits to connect the connector and the car body and create earthing path through the resin tube, the connector and a side of the car body (earth member) corresponding to various locational relationship between the connector and the car body. If the mounting portion, the connective portion and the connecting portion are formed from same material or identical material, these three portions are preferably formed as a unit.

The mounting portion of the antistatic protector for resin tube has elasticity. Therefore in case that the mounting portion is properly constructed, the antistatic protector may be mounted to the outer periphery of the connector easily or relatively easily. The mounting portion may be formed as an annular member to be mounted to or fitted on the outer periphery of the connector. Also, the mounting portion may be constructed by a pair of halved portions which are joined each other to form the annular member so as to be mounted to the outer periphery of the connector with the connector therebetween. Further, the mounting portion may be formed in a cap configuration (cover configuration) so as to cap on the outer periphery of the connector. It simplifies a structure of the antistatic protector and improves mounting property thereof to construct the mounting portion in an annular shape. However, if a tube connecting portion of the connector has a bent portion formed in a curved manner, a force has to be exerted for the mounting portion to pass the tube connecting portion while gradually changing its direction along the bent portion and thereby mounting procedure becomes troublesome. And, the mounting portion as annular member has to be fitted on the connector prior to fitting of the tube on the tube connecting portion. But, in many cases, the resin tube is fitted thereon while grasping a side of the connector by jig. Therefore, due to the mounting portion fitted on the connector, if the connector cannot be grasped by jig, it might be necessary that the mounting portion is displaced toward the tube connecting portion for once. However, in the connector having a tube connecting portion formed in curved manner, it is troublesome to displace the mounting portion once and return it in mounting position. Therefore, according to the circumstances, the antistatic protector is constructed such that the mounting portion is formed by a pair of halved portions or in cap configuration, for example, to enable to mount the mounting portion on the connector after the resin tube is fitted on the tube connecting portion.

The connecting portion of the antistatic protector for resin tube has also elasticity. Therefore, if the connecting portion is properly constructed, the antistatic protector may be connected to the earth member easily or relatively easily. And, the connecting portion may be constructed to have a through hole, slit or through slit. Here, the antistatic protector or the connecting portion is connected to the earth member, for example, by passing the earth member through the through hole or the through slot, or inserting the earth member in the slit.

The antistatic protector may be constructed such that the mounting portion, for example, an inner surface of the mounting portion contacts closely with the outer periphery of the connector and the connecting portion, for example, the through hole, slit or through slit contacts closely with the earth member. Thus configured antistatic protector may have mounting property and electrically connecting property with enhanced stability.

Conductive elastic material, for example, conductive rubber elastic material may be obtained by mixing carbon powder or stainless steel powder and the like in rubber or elastomer material. Conductive plastic is also applicable as conductive elastic material.

In order to enhance ability of the antistatic protector to flexibly follow the locational relationship between the connector and the car body or the side of the car body, the mounting portion is preferably mounted on the outer periphery of the connector rotatably.

If the connecting portion is formed in shape so as to be easily gripped by fingers, the earth member is easily passed through or inserted in, for example, through hole, slot or through slot Therefore, the connecting portion is easily connected to the earth member, and thereby the antistatic protector is connected to the connector and the earth member easily. Accordingly, the connecting portion may be provided integrally with one or more finger grip portions projecting outwardly. If the finger grip portions are formed on opposite ends of the connecting portion respectively, the connecting portion may be connected to the earth member by grasping the finger grip portions with fingers of both hands respectively, and thereby the antistatic protector is connected to the connector and the earth member more easily. The finger grip portion or finger grip portions may be formed integrally on the mounting portion or on opposite ends of the mounting portion.

The connector may be formed with a pair of positioning surfaces expanding radially outwardly on an outer periphery in axially spaced and opposed relation, and the mounting portion may be fitted and positioned between a pair of the positioning surfaces to be positioned axially. It may be effectively prevented without complicating a mounting structure that the mounting portion is displaced due to vibration in a moving car or the like resulting in failure in contact with the connector. As the connector typically includes a stepped portion on an outer periphery thereof in many cases, an end surface of the stepped portion expanding radially outwardly is applicable as positioning surface.

As described above, the antistatic protector for resin tube according to the present invention enables to easily construct antistatic structure for resin tube according to connecting structure in variety of piping system.

Now, the preferred embodiments of the present invention will be described in detail with reference to the drawings.

### BRIEF DESCRIPTION OF THE DRAWINGS

FIG. 1 is a view of schematic arrangement of fuel piping for vehicle in which an antistatic protector for resin tube according to the present invention is to be applied.

FIG. 2 is a perspective view of a quick connector.

FIG. 3 is a sectional view of the quick connector.

FIG. 4 is a perspective view of a retainer.

FIG. 5 is a sectional view showing the state that a resin tube and a pipe are connected to the quick connector.

FIG. 6 is a perspective view of a first antistatic protector for resin tube according to the present invention.

FIG. 7 is a perspective view showing in detail the state that the first antistatic protector for resin tube according to the present invention is mounted and connected to the quick connector and earth member.

FIG. 8 is a perspective view showing the state that the first antistatic protector for resin tube according to the present invention is mounted and connected to the quick connector and the earth member in different manner.

FIG. 9 is a perspective view of a second antistatic protector according to the present invention.

FIG. 10 is a perspective view showing the state that the second antistatic protector according to the present invention is mounted and connected to the quick connector and the earth member.

FIG. 11 is a perspective of a quick connector with another configuration.

FIG. 12(a) is a view explaining process of connecting the connecting portion to the earth member, and showing the state before the connecting portion is relatively inserted in the earth member.

FIG. 12(b) is a view explaining process of connecting the connecting portion to the earth member, and showing the state that the connecting portion is relatively inserted in the earth member.

FIG. 13 is a perspective view of a third antistatic protector for resin tube according to the present invention.

FIG. 14 is a perspective view showing the state that the third antistatic protector for resin tube according to the present invention is mounted and connected to the quick connector and the earth member.

### DETAILED DESCRIPTIONS OF PREFERRED EMBODIMENTS

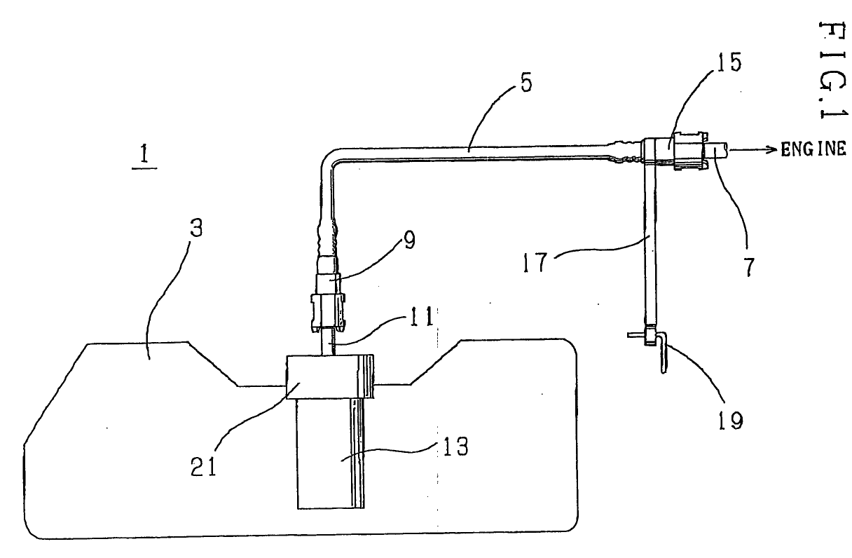

As shown in FIG. 1, fuel piping 1 where a fuel tank 3 is connected with an engine in vehicle, comprises a resin (plastic) tube 5 formed in curved manner, a metal pipe 7 connected with one end portion of the resin tube 5 and continued to an engine side, and a quick connector 9 to connect an outlet 11 of a fuel pump 13 provided on the fuel tank 3 and an opposite end portion of the resin tube 5. The fuel piping 1 further comprises another quick connector 15 to connect one end portion of the resin tube 5 and the metal pipe 7. As the resin tube 5 includes a bent portion which is curved largely, friction with gasoline flowing in the resin tube 5 becomes higher especially in the bent portion of the resin tube 5. On an outer periphery of the quick connector 15, one end portion of a first antistatic protector for resin tube 17 is fitted, and an opposite end portion thereof is connected to earth member 19 provided on a car body. The fuel pump 13 has a filter or strainer 21 just before the outlet 11 to filter gasoline fuel, the gasoline passes through the filter 21 and is fed in the resin tube 5.

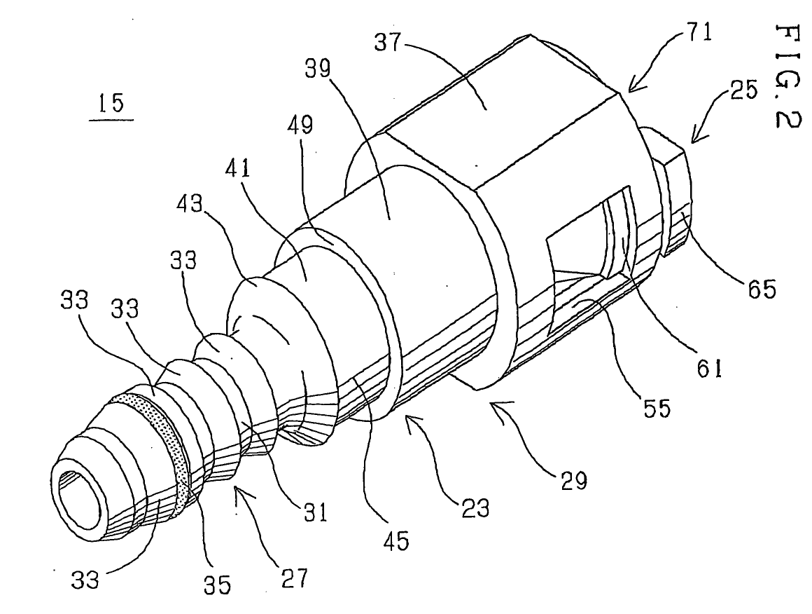

As well shown in FIG. 2, the quick connector 15 comprises a tubular connector housing 23, and a generally annular retainer 25. The connector housing 23 is made of glass fiber reinforced polyamide (PA•GF) as molding material in which carbon powder or stainless steel powder is mixed. The connector housing 23 integrally comprises a cylindrical resin tube connecting portion 27 on one axial end thereof and a generally cylindrical pipe inserting portion 29 on an opposite axial end thereof The connector housing 23 has relatively favorable conductivity as carbon power or stainless steel powder which is mixed in the material decreases electrical resistance or electrical resistance value.

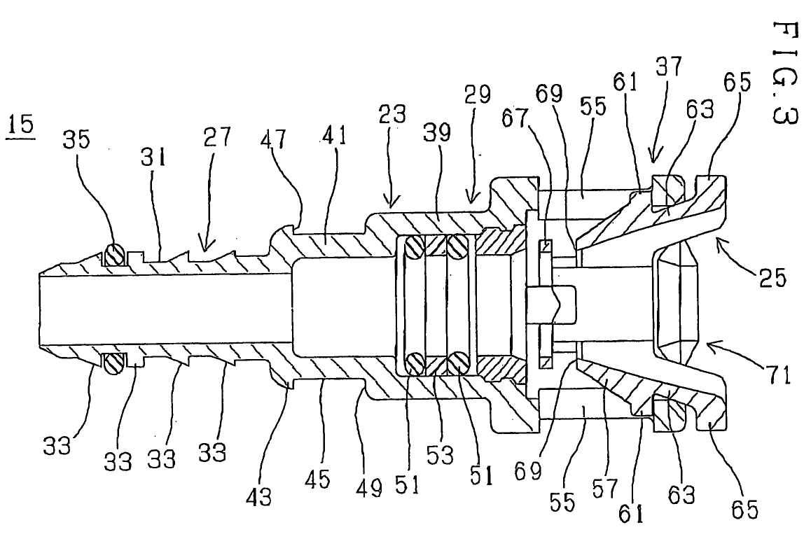

As well shown in FIGS. 2 and 3, the tube connecting portion 27 has an cylindrical outer peripheral surface 31 where a plurality of annular projecting portions 33 are formed axially spaced relation with one another. On an outer peripheral surface between two annular projecting portions 33, 33 on one axial end of the tube connecting portion 27, an O-ring 35 made of rubber is fitted to provide a seal with respect to the resin tube 5.

The pipe inserting portion 29 of the connector housing 23 integrally has a retainer holding portion 37 of large diameter on an opposite axial end, a seal holding portion 39 and a transitional portion 41 on one axial end. The seal holding portion 39 is smaller in diameter than the retainer holding portion 37 and is located halfway between the retainer holding portion 37 and the transitional portion 41. The transitional portion 41 is further smaller in diameter than the seal holding portion 39 but larger in diameter than the tube connecting portion 27. An outer peripheral surface of the transitional portion 41 is formed with an annular positioning projecting portion 43 on one axial end portion which projects radially outwardly. An outer periphery of the transitional portion 41 defines a fit portion 45 between an opposite end surface 47 (positioning surface) of the annular positioning projecting portion 43 and the stepped surface 49 (positioning surface) between the transitional portion 41 and the seal holding portion 39 or located at an opposite axial end of the transitional portion 41.

Within an inner surface of the seal holding portion 39, a pair of O-rings 51, 51 made of rubber are fitted axially spaced in side by side relation with intervening a collar 53 to provide a seal with respect to the pipe 7.

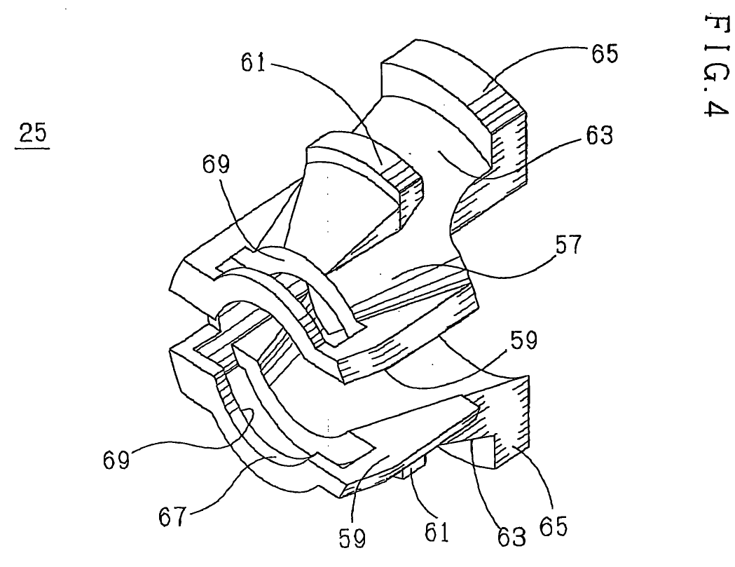

The generally cylindrical retainer holding portion 37 is provided with engagement windows 55, 55 of identical shape in diametrically symmetrical positions and in opposed relation with one another. The retainer 25 made of PA is received and fitted in the thus configured retainer holding portion 37. As well shown in FIG. 4, this retainer 25 has a main body 57 of C-shape in cross-section, wherein a relatively large space for deformation is defined between circumferential opposite end portions 59, 59 thereof. The main body 57 is provided with a pair of engagement tabs 61, 61 projecting radially outwardly in diametrically symmetrical positions of an opposite axial end portion thereof. A pair of operation arms 63, 63 are formed integrally on an opposite axial end portion of the main body 57 of the retainer 5 so as to extend inclining radially outwardly in an opposite axial direction from respective circumferential positions corresponding to the engagement tabs 61, 61. Each of the operation arms 63, 63 has a latching end 65 projecting radially outwardly on an opposite axial end portion thereof. One axial end portion 67 of the main body 57 is provided with engagement slits 69, 69 extending circumferentially in opposed relation with one another. Thus configured retainer 25 is inserted into an opening 71 on an end of the retainer holding portion 37 and fitted in the retainer holding portion 37, so that the engagement tabs 61, 61 seat in the engagement windows 55, 55 of the retainer holding portion 37 in engagement relation therewith and the latching ends 65, 65 engage with an opposite axial end of the retainer holding portion 37.

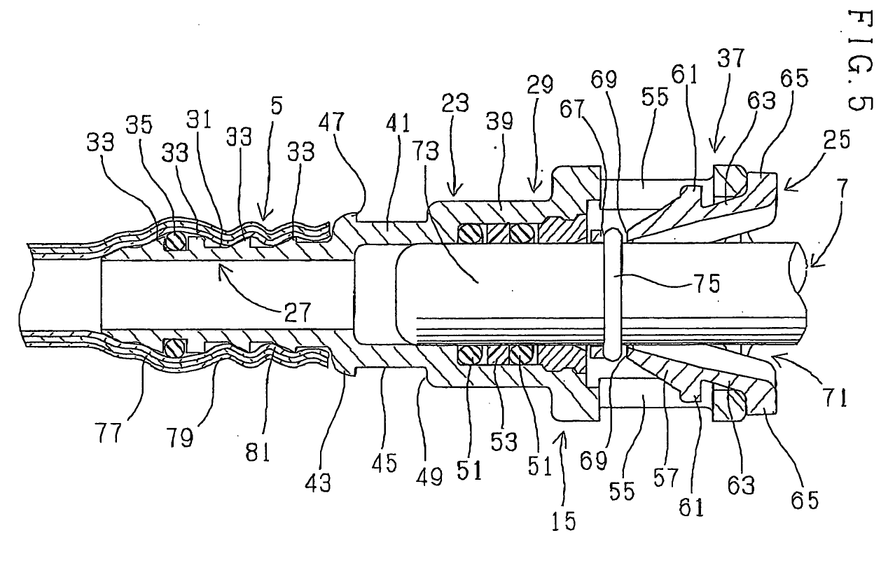

With reference to FIG. 5, the pipe 7, made of metal and with surface or outer surface coated with nylon for anti-rust purpose, is inserted into the opening 71 on an end of the retainer holding portion 37 and fitted in the quick connector 15. The pipe 7 has an inserting end portion 73 which is provided with an annular engagement projection 75 on an outer peripheral surface thereof. The pipe 7 is pushed, and fittingly inserted into the pipe inserting portion 29 until the annular engagement projection 75 seats in the engagement slits 69, 69 of the retainer 25 in snap-engagement relation therewith.

The resin tube 5 has multi-layered construction including inner layer 77 of low gasoline fuel permeability and heat resistant outer layer 79. The inner layer 77 is made of ethylene tetrafluoroethylene (ETFE) and an inner peripheral surface side of the inner layer 77 constructs conductive layer 81 in which carbon powder or stainless steel powder is mixed. The heat resistant outer layer 79 is made of PA12. Thus configured resin tube 5 is tightly fitted on and connected to an outer periphery of the tube connecting portion 27 of the quick connector 15 while the conductive layer 81 is in contact relation with the tube connecting portion 27. As a matter of convenience, FIG. 5 shows the resin tube 6 without the first antistatic protector 17.

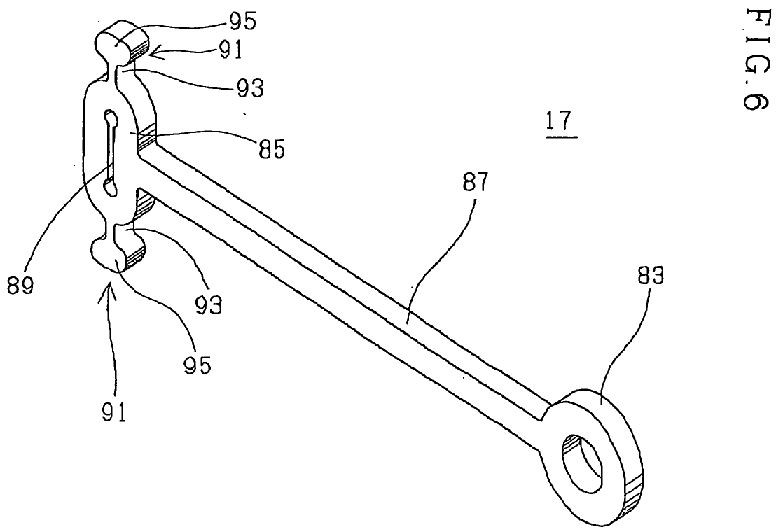

As well shown in FIG. 6, the first antistatic protector for resin tube 17 integrally comprises an annular mounting portion 83 on one end portion, an elliptic connecting portion 85 on an opposite end portion, a relatively elongate or long slender connective portion 87 bridging between or joining (jointing) the mounting portion 83 and the connecting portion 86. The mounting portion 83, the connecting portion 86 and the connective portion 87 all are formed flexible and from material of ethylene propylene diene rubber or ethylene-propylene-diene copolymer (EPDM) in which carbon powder or stainless steel powder is mixed so as to have electrical conductivity where volume resistivity is maximum 1×10⁶Ωcm. The connecting portion 85 is formed relatively long or extending relatively long in a direction perpendicular to the extending direction of the connective portion 87. The connecting portion 85 has a through slit 89 extending in a longitudinal direction of the connecting portion 85 with narrow width. Opposite ends of the through slit 89 are formed in circular aperture in order to prevent cracking. The mounting portion 83 has a thickness generally equal to an axial length of the fit portion 45 defined on the outer periphery of the transitional portion 41 of the quick connector 15, and an inner diameter slightly smaller than an outer diameter of the outer peripheral surface of the transitional portion 41 or the fit portion 45. The connecting portion 85 is formed integrally with a pair of finger grip portions 91, 91 (portions to be gripped with fingers when the connecting portion 85 is connected and removed) projecting outwardly corresponding to ends of the through slit 89 at longitudinal opposite ends. Each of finger grip portions 91, 91 has a narrow-width outgoing portion 93 extending outwardly from the connecting portion 85, and a large grip body 95 formed integrally at outer end of the outgoing portion 93.

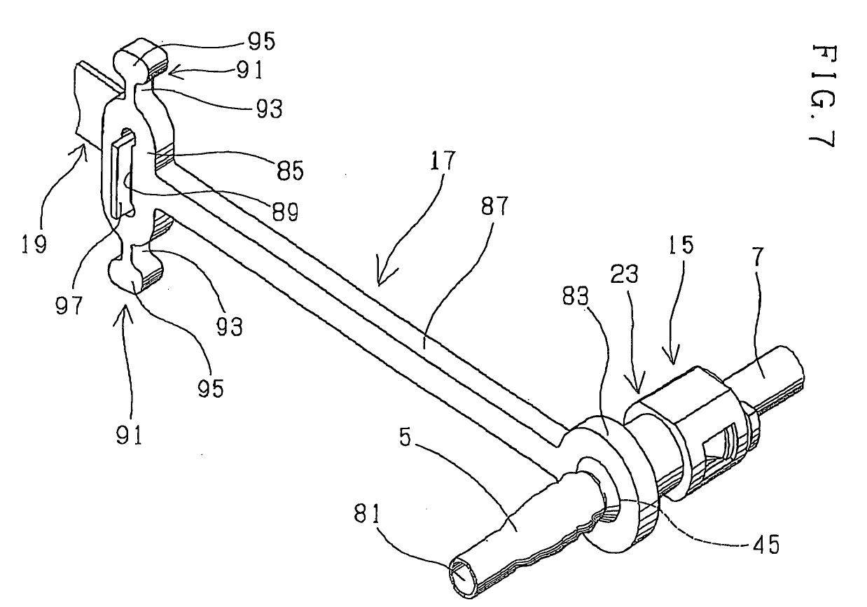

With reference to FIG. 7, the first antistatic protector 17 is mounted on the outer periphery of the connector housing 23 of the quick connector 15 so as to be positioned thereon by fitting the mounting portion 83 in the fit portion 45 configured on the outer periphery of the transitional portion 41 of the quick connector 15. By the way, FIG. 7 and so on shows the quick connector 15 and the earth member 19 in locational relation which is changed properly for better understanding. The mounting portion 83 has an inner diameter slightly smaller than an outer diameter of an outer peripheral surface of the fit portion 45. However, as the mounting portion 83 has rubber elasticity, the mounting portion 83 can rotate over the connector housing 23 in a direction circumferentially of the connector housing 23. Meanwhile, the mounting portion 83 is typically fitted on the fit portion 45 of the quick connector 15 before the resin tube 5 is connected to the tube connecting portion 27 of the quick connector 15.

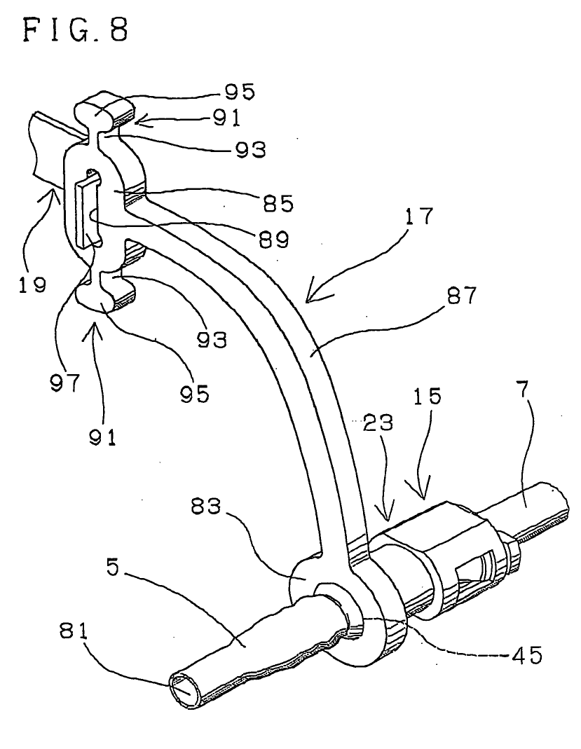

Further, the first antistatic protector 17 is fitted to and connected to the earth member 19 by inserting a bent end portion 97, for example, of plate shape, of the earth member 19 through the through slot 89 of the connecting portion 85. A width of the through slot 89 of the connecting portion 85 is slightly narrower than a thickness of the bent end portion 97, of the earth member 19. The connecting portion 85 is connected to the earth member 19, for example, by gripping the grip bodies 96, 96 of finger grip portions 91, 91 with fingers of both hands respectively. In the first antistatic protector 17, the connecting portion 85 may be connected to the earth member 19, as shown in FIG. 8; such that the connective portion 87 is bowed and the mounting portion 83 is rotated over the connector housing 23 so as to correspond to the locational relationship between the quick connector 15 and the earth member 19.

The first antistatic protector 17 which is mounted on the connector 15 and connected to the earth member 19 creates an earthing path from the conductive layer 81 of the resin tube 5, via the connector housing 23 and the first antistatic protector 17 to the earth member 19.

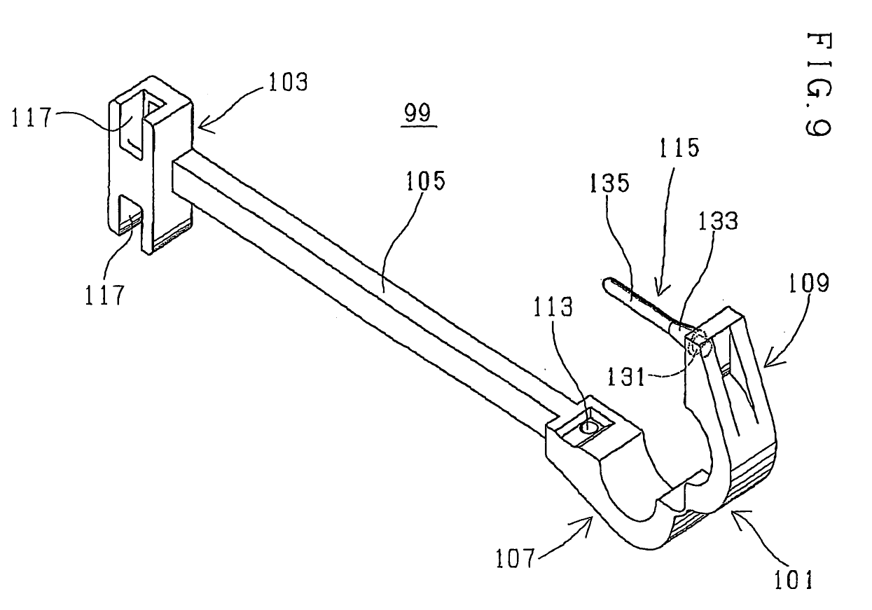

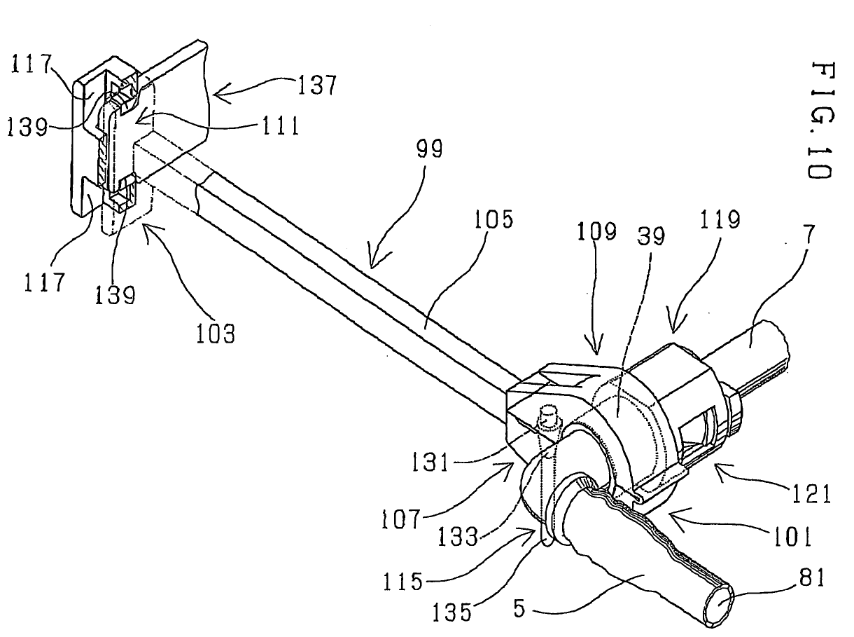

With reference to FIGS. 9 and 10, a second antistatic protector 99 integrally comprises a mounting portion 101 on one end portion, a connecting portion 103 on an opposite end portion, and a relatively long or long slender connective portion 105 bridging between or joining (jointing) the mounting portion 101 and the connecting portion 103. The mounting portion 101 has a pair of halved portions 107, 109, and the connecting portion 103 has a connecting slit 111. The mounting portion 101, the connecting portion 103 and the connective portion 105 all are formed flexible and from material of EPDM in which carbon powder or stainless steel powder is mixed so as to have electrical conductivity where volume resistivity is maximum 1×10⁶ Ωcm.

The mounting portion 101 is constructed by the one halved portion 107 and the other halved portion 109 which are hinged as a unit with one another at longitudinal outer ends (outer ends in the extending direction of the second antistatic protector 99 or the connective portion 105). A longitudinal inner end of the one halved portion 107 continues or is connected integrally to one end or one longitudinal end of the connective portion 105. Therefore, the other halved portion 109 is configured to rotate on a longitudinal outer end in an opening and closing direction with respect to the one halved portion 107. The one halved portion 107 is formed with a pin receptacle hole 113 on a longitudinal inner end portion, while the other halved portion 109 is formed integrally with a connect pin 115 on a longitudinal inner end portion. The one halved portion 107 and the other halved portion 109 are constructed to be joined and hold in joined relation with one another by interconnection of the connect pin 115 and the pin receptacle hole 113 or by inserting the connecting pin 115 in the pin receptacle hole 113. The one halved portion 107 and the other halved portion 109 in joined relation, where inner end portions contact with one another, form annular member.

The connecting portion 103 is formed in a rectangular parallelepiped shape extending long in a direction perpendicular to an longitudinal direction of the second antistatic protector 99. An inner surface or a longitudinal inner surface of the connecting portion 103 is continued or connected integrally to an opposite end or a longitudinal opposite end of the connective portion 105. One side surface of the connecting portion 103 has recessed portions 117, 117 on opposite ends longitudinally of the connecting portion 103. The connecting slit 111 is formed to extend from an opposite side surface of the connecting portion 103 to a position beyond a bottom surface of the recessed portion 117.

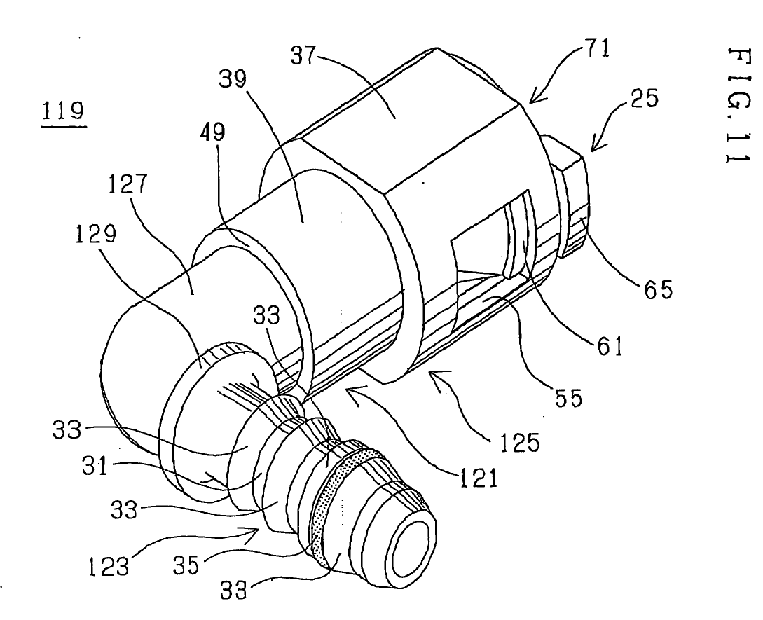

The second antistatic connector for resin tube 99 is to be mounted to a quick connector 119 to be adapted for connection of the resin tube 5 and the pipe 7 in the fuel piping 1. The quick connector 119 has a configuration different from the quick connector 15 (refer to FIG. 11). The quick connector 119 is constructed by modifying configuration of the tube connecting portion 27 and the transitional portion 41 of the connector housing 28 of the quick connector 15. Therefore, as to portions of configuration and functions identical to the quick connector 15, identical numeral references are almost given and explanations are almost omitted herein. The quick connector 119 has a connector housing 121 including a tube connecting portion 123 and a pipe inserting portion 125. The tube connecting portion 123 is formed integrally on a transitional portion 127 in connected relation, at an angle of 90° with respect to the pipe inserting portion 125. The tube connecting portion 123 is provided with an annular flange portion 129 at a root position to stop further advance movement of the resin tube 5 which is fitted thereon. The tube connecting portion 123 has identical or the same configuration as the tube connecting portion 27 with respect to a portion on which the resin tube 5 is fitted. The transitional portion 127 is formed with one axial end portion which is smoothly rounded. The quick connector 119 is adapted to the resin tube 5 which has a bent portion shaped different from that in FIG. 1.

The second antistatic protector 99 is mounted to the quick connector 119 by inserting the connect pin 115 of the other halved portion 109 in the pin receptacle hole 113 of the one halved portion 107 so that the one halved portion 107 and the other halved portion 109 are joined while embracing the seal holding portion 39 of the quick connector 119 therebetween. The connect pin 115 has a short small diameter portion 131 integrally connected to an inner end portion of the other halved portion 109, a tapered portion 133 formed integrally on a top end of the small diameter portion 131, and a relatively long insert portion 135 with small diameter formed integrally on a top end of the tapered portion 133. The tapered portion 133 is formed so as to diametrically gradually contract in a leading direction, and has a root end diametrically larger than the small diameter portion 131. Here, the small diameter portion 131 and the insert portion 135 are formed generally equally in diameter. The pin receptacle hole 113 of the one halved portion 107 has an inner diameter slightly larger than an outer diameter of the insert portion 135 and the small diameter portion 131 (an inner diameter smaller than an outer diameter of the root end of the tapered portion 133) and a length generally equal to the small diameter portion 131 The tapered portion 133 of the connect pin 115 passes through the pin receptacle hole 113, peripheries of opposite sides of the pin receptacle hole 113 are sandwiched by and between the tapered portion 133 and an inner end portion of the other halved portion 109, thereby the one halved portion 107 and the other halved portion 109 construct the annular member which contacts closely with an outer peripheral surface of the seal holding portion 39 of the quick connector 119 and is maintained in annular shape. The annular member which is constructed by joining the one halved portion 107 and the other halved portion 109, in many cases, can rotate with respect to the quick connector 119.

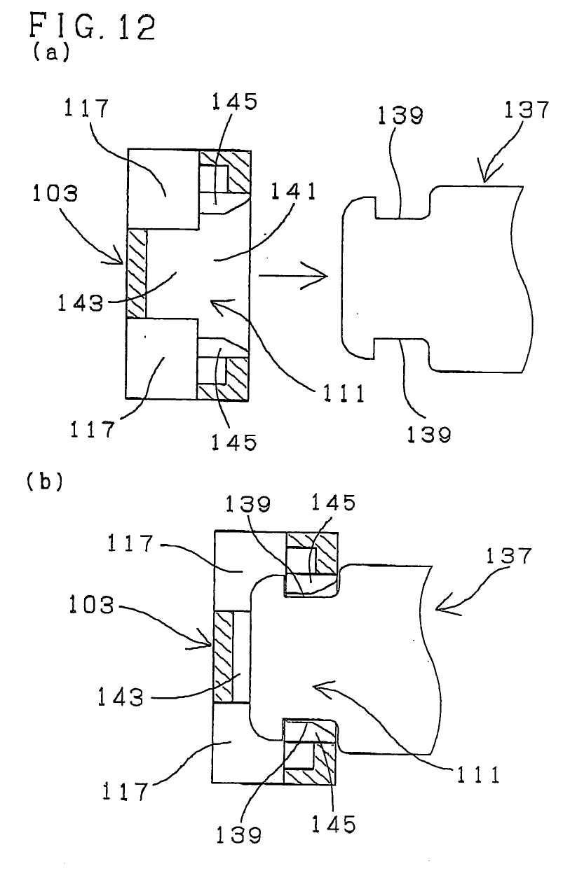

The second antistatic protector 99 is connected to the earth member 137 by inserting the earth member 137 in the connecting slit 111 of the connecting portion 103. The earth member 137 has different configuration from the earth member 19, and is formed in a plate shape which has engagement recesses 139, 189 on widthwise opposite ends near inserting end A leading side or leading end portion of the engagement recesses 139, 139 of the earth member 137 has a width somewhat larger than a width of the connecting slit 111 (an entry side portion 141 of the connecting slit 111, also refer to FIG. 12a). When the earth member 137 is relatively inserted in the connecting slit 111 until the leading end portion of the earth member 137 passes through the entry side portion 141 of the connecting slit 111 (refer to FIG. 12b), the leading end portion of the earth member 137 enters in an opposite side portion 143 of the connecting slit 111. The opposite side portion 143 of the connecting slit 111 has a width narrower than the entry side portion 141 of the connecting slit 111 as the recessed portions 117, 117 are formed, and is open into the recessed portion 117, 117 at widthwise opposite ends. Therefore, widthwise opposite ends of the leading portion of the earth member 137 protrude widthwise outwardly from the opposite side portion 143 of the connecting slit 111, enter in the recessed portions 117, 117 and thereby the bottom surfaces of the recessed portions 117, 117 engage with the earth member 137 in a pull-out direction. Further, side wall portions 145, 145 which define the entry side portion 141 of the connecting slit 111 enter in the engagement recesses 139, 139, and thereby the connecting portion 103 engages with the earth member 137 also in an inserting direction. The side wall portions 145, 145 are configured so as to be easily deformed and displaced in a widthwise outward direction when pushed by widthwise opposite ends of the leading portion of the earth member 137.

The connecting slit 111 is configured so as to contact closely with the earth member 137 which is inserted therein. The second antistatic protector 99 which is mounted to the connector 119 and connected to the earth member 137 creates an earthing path from the conductive layer 81 of the resin tube 5, via the connector housing 121 and the second antistatic protector 99 to the earth member 137. Just like the first antistatic protector 17, the second antistatic protector 99 also has a sufficient ability to flexibly follow the locational relationship between the quick connector 119 and the earth member 137.

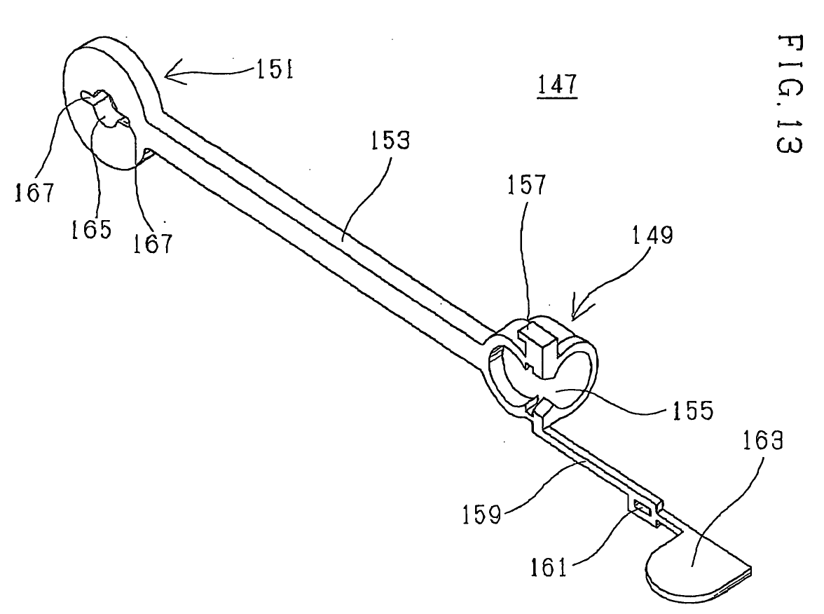

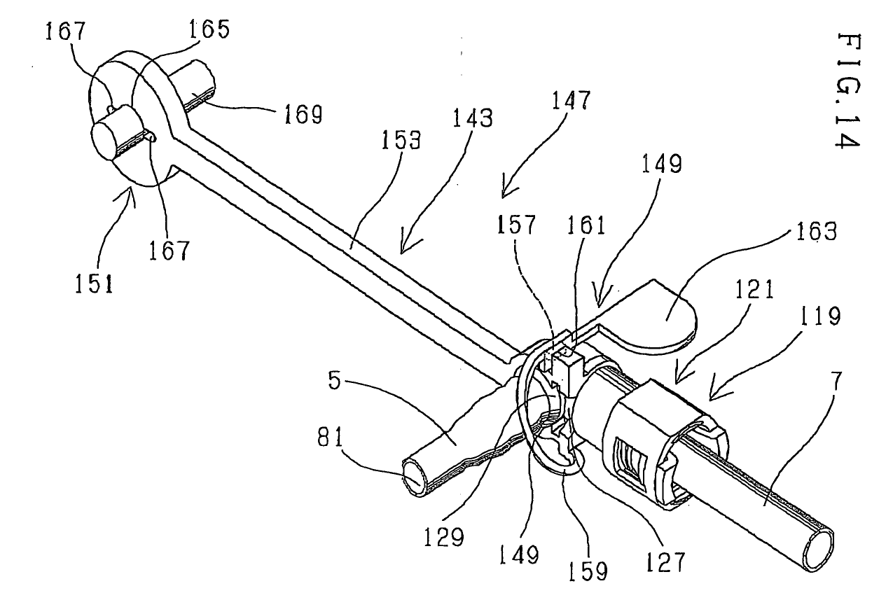

With reference to FIGS. 13 and 14, a third antistatic protector for resin tube 147 integrally comprises a mounting portion 149 of cap shape on one end portion, an annular or circular connecting portion 151 on an opposite end portion, and a relatively elongate or long slender connective portion 153 bridging between or joining (jointing) the mounting portion 149 and the connecting portion 151. The mounting portion 149, the connecting portion 151 and the connective portion 163 all are formed flexible and from material of EPDM in which carbon powder and stainless steel powder is mixed so as to have conductivity where volume resistivity is maximum 1×10⁶Ωcm.

The mounting portion 149 is formed in cap configuration in elbow shape, having a fit-on opening 155 inside and configured to be mounted on the quick connector 119 from the transitional portion 127 to the flange portion 129 of the tube connecting portion 123, or cap on the quick connector 119 from the transitional portion 127 to the flange portion 129 of the tube connecting portion 123 or to a portion near the flange portion 129. A receiving portion of the mounting portion 149 to receive a side of the flange portion 129 is integrally continued or connected to one end or one longitudinal end of the connective portion 153. The mounting portion 149 has an inner surface shaped generally along an outer peripheral surface extending from the transitional portion 127 of the quick connector 119 to the flange portion 129 or the portion near the flange portion 129 of the tube connecting portion 123, and is configured to receive the quick connector 119 from the transitional portion 127 to the flange portion 129 or the portion near the flange portion 129 of the tube connecting portion 123 in circumferential extent of over 180°.

The mounting portion 149 is formed integrally with an engagement lug 157 and a narrow and relatively long verifying portion 159 across the fit-on opening 155 on an opposite side of the engagement lug 157. The verifying portion 159 is provided with a stopper hole 161 on a leading end portion and a finger grip portion 163 on a leading side of the stopper hole 161.

The connecting portion 151 is formed with a circular fit-in hole 166 and opening cutaways 167, 167 on opposite ends of the fit-in hole 165 respectively. An outer periphery of the connecting portion 151 is continued or connected integrally to an opposite end or a longitudinal opposite end of the connective portion 153.

In the third antistatic protect or 147, the mounting portion 149 is capped and fitted on the quick connector 119 from the transitional portion 127 to the flange portion 129 or the portion near the flange portion 129 of the tube connecting portion 123 via the fit-on opening 155, the verifying portion 159 is bowed or curved by gripping the finger grip portion 163 of the verifying portion 159 with fingers so as to insert the engagement lug 157 in the stopper hole 161. In this state, the verifying portion 159 crossing over the fit-on opening 155 prevents the mounting portion 149 from coming off. And, mounting of the third antistatic protector 147 may be verified by checking a status of the finger grip portion 163 at a later inspection. That is, the finger grip portion 163 is applicable as a flag for verifying mounting of the third antistatic protector 147.

The third antistatic protector 147 is fitted to and connected to the earth member 169 by inserting the earth member 169 in the fit-in hole 165 of the connecting portion 151 of disk shape. The earth member 169 has different configuration from the earth member 19 and is shaped of round rod. The fit-in hole 165 has an inner diameter slightly smaller than an outer diameter of the earth member 169, receives the earth member 169 in the state enlarged by the opening cutaways 167, 167 and contacts closely with the outer periphery of the earth member 169.

The third antistatic protector 147, which is mounted to the connector 119 and connected to the earth member 169, creates an earthing path from the conductive layer 81 of the resin tube 5, via the connector housing 121 and the third antistatic protector 147 to the earth member 169. Just like the first antistatic protector 17, the third antistatic protector 147 also has a sufficient ability to flexibly follow the locational relationship between the quick connector 119 and the earth member 169.

We claim:

1. An antistatic protector to be mounted to a conductive connector for joining a resin tube and a pipe in automotive piping to earth the resin tube via the conductive connector, comprising;
a mounting portion to be mounted to an outer periphery of the conductive connector,
a connecting portion to be connected to an earth member provided on a car body,
an elongate or relatively elongate connective portion to joint the mounting portion and the connecting portion, and
the mounting portion, the connecting portion and the connective portion being formed from conductive elastic material so as to have flexibility respectively.

2. The antistatic protector as set forth in claim 1 wherein the mounting portion, the connecting portion and the connective portion are formed as a unit.

3. The antistatic protector as set forth in claim 1 wherein the mounting portion is formed as an annular member so as to be fitted on and mounted to the outer periphery of the connector.

4. The antistatic protector as set forth in claim 1 wherein the mounting portion is constructed by a pair of halved portions which are joined each other to form the annular member,
the annular member is configured so as to be mounted to the outer periphery of the conductive connector with the conductive connector therebetween.

5. The antistatic protector as set forth in claim 1 wherein the mounting portion is formed in a cap configuration so as to be capped on and mounted to the outer periphery of the conductive connector.

6. The antistatic protector as set forth in claim 3 wherein the mounting portion is mounted to the outer periphery of the connector rotatably.

7. The antistatic protector as set forth in claim 4 wherein the mounting portion is mounted to the outer periphery of the connector rotatably.

8. The antistatic protector as set forth in claim 1 wherein the connecting portion is provided integrally with one or more finger grips projecting outwardly.

9. The antistatic protector as set forth in claim 8 wherein the finger grips are formed on opposite sides of the connecting portion respectively.

10. The antistatic protector as set forth in claim 3 wherein the conductive connector is formed with a pair of positioning surfaces expanding radially outwardly on an outer periphery in axially spaced and opposed relation, and the mounting portion is to be mounted between a pair of the positioning surfaces to be positioned axially.

11. The antistatic protector as set forth in claim 4 wherein the conductive connector is formed with a pair of positioning surfaces expanding radially outwardly on an outer periphery in axially spaced and opposed relation, and the mounting portion is to be mounted between a pair of the positioning surfaces to be positioned axially.
